(19) United States
(12) Patent Application Publication
(10) Pub. No.: US 2005/0231374 A1
(43) Pub. Date: Oct. 20, 2005

(54) Data management system

(76) Inventors: Bjorn Henrik Diem, Berlin (DE); Stefan Paule, Drosendorf (DE); Norbert Petsch, Erlangen (DE); Albrecht Urbaszek, Hausen (DE)

Correspondence Address: HAHN LOESER & PARKS, LLP, One GOJO Plaza, Suite 300, AKRON, OH, 44311-1076, US

(21) Appl. No.: 11/106,022

(22) Filed: Apr. 14, 2005

(30) Foreign Application Priority Data
Apr. 15, 2004 (EP) 04 090 144.9

(51) Int. Cl. G08B 23/00

(52) U.S. Cl. 340/573.1

(57) ABSTRACT

A data management system for processing of physiological or technical data or both to generate a display control signal is disclosed. The data system comprises a data interface having a patient data interface and a user interface. The patient data interface is adapted to receive data which represent physiological parameters of a patient or technical parameters of a medical device, in particular of an implant such as a cardiac pacemaker, defibrillator, or cardioverter, for example. The user interface is adapted to receive data to be entered by a user. The user interface may be a keyboard or a touch screen or a voice interface, for example.

This application claims priority to European Patent application EP 04 090 144.9 filed on Apr. 15, 2004, which is incorporated herein by reference in its entirety.

The invention relates to a data management system for processing of physiological or technical data or both to generate a display control signal. The data management system comprises a data interface have a patient data interface and a user interface. The patient data interface is adapted to receive data which represent physiological parameters of a patient or technical parameters of a medical device, in particular of an implant like a cardiac pacemaker or a defibrillator, cardioverter or the like. The user interface is adapted to receive data to be entered by a user. The user interface may be a keyboard or a touch screen or a voice interface.

The data management further comprises a data base adapted to store data received via the patient data interface and to retrieve stored data. Furthermore, the data management system comprises a processing unit which is at least indirectly connected to the user interface and to a rule base. Said processing unit is adapted to retrieve and to process data stored in the data base according to rules which are stored in the rule base, thereby creating a display control signal for a graphical data display such that the display control signal depends on said data and said rules.

Such data management system in general is already known and serves for the purpose to remotely display data gathered for example by an implant, see for example WO 2004/000111, WO 03/090150, WO 03/088830, WO 03/077752, WO 02/082984, WO 02/07816 and WO 02/02004. Such data management system is used in a so called home monitoring environment wherein multiple implants are linked to a central service center via wireless or landline telemetry. Data received from the implants is stored in a central data base and can be retrieved for example by a physician to determine the latest health states of a patient or operational states of the implant.

Data gathered by the implants can be technical data relating to the implant itself, for example the states of the pacing leads of a pacemaker or the states of a pacemaker's battery. The data collected by the implant as well include physical data related to the patient like a natural heart rate of the patient, events of tachycardia or fibrillation or all kind of other data which can be collected automatically by an implantable medical device (IMD).

An advantage of such a home monitoring environment is that a physician has central access to a large number of data allowing all kind of comparisons or calculations or statistics. On the other hand, physicians are many times facing an information overload.

It is an object of the invention to provide for an improved data management system.

According to the invention, the object is achieved by a data management system according to claim 1 wherein said processing unit is connected to a rule base and adapted to process the data stored in the data base according to the rules stored in the rule base. It has proven to be advantageous, if the data base for collected data and a rule base defining how the data has to be processed are separate from each other. This is to be understood, that a rule base is not a program in the usual sense even though a program also defines rules as how to process data. A rule base comprises a set of rules. A program like an expert system accesses these rules in order to process data stored in the data base. In a sense a rule base is a kind of a meta program. The advantage of a rule base is that the rules are easily accessible and easily manageable by a physician without programming skills.

The rules stored in the rule base comprise rules defining alarm states in a way that an alarm state is to be determined by the processing unit, if the data stored in the data base indicate an acute health disaster of a patient or an acute failure of a device. The processing unit is adapted to create a display control signal for displaying an alarm symbol depending on a user identification signal received from the user interface such that for each patient or device being assigned to an identified user all actual alarm states are immediately displayed by an alarm symbol.

When using such data management system, a physician first has to identify himself for example by logging in into a computer, thereby creating an identification signal. Then, all actual alarm states are displayed to the physician. This avoids the need for a physician to manually determine whether any of the patient or devices to be cared for by the physician is in a critical state. In addition, a physician himself or any other expert can set up the rules which lead to the display of an alarm state so that the rules a physician would apply to determine a critical state manually can be entered beforehand in order to automatically create alarm symbols displaying all actual alarm states.

In a preferred embodiment the rule base comprises rules which define warning states such that a warning state is determined by the processing unit if said data indicates an upcoming health complication or a minor technical failure. In such preferred embodiment the processing unit is adapted to generate a display control signal displaying for each patient or device being assigned to an identified user a warning symbol on a display, if for said patient or device a warning state as defined by the rule base is given by an actual set of data for said patient or device. A warning state is defined by data, which indicate a less hazardous health complication or technical failure compared to an alarm state. The rules defining a warning state are also configurable by a physician or another expert. Having two different kinds of symbols for different degrees of health complications further improves the overview a physician gains by using the inventive data management system. For example, alarm states may be indicated by a red alarm symbol, whereas warning states may be indicated by a yellow or orange warning symbol.

A further improvement of the data management system comprises a processing unit which is adapted to generate a display control signal to display an ok-symbol for each person or device for which neither a warning state nor an alarm state is given. Such an ok-symbol may be of green color in order to easily discriminate the ok-symbol from an alarm symbol or a warning symbol. To discriminate between three states, alarm state, warning state and ok-state, has proven to be very useful in order to provide for an easy access to the information stored in the data base without over-simplifying the information.

The processing unit is preferably adapted to receive a user identification signal via the user interface and to immediately generate a display control signal which initiates immediate display of all actual alarm symbols given by an actual set of data being assigned to patients or devices associated to the user identified by the identification signal. A further improved processing unit is adapted to also immediately display all actual warning states. Displaying all alarm states and, in a preferred embodiment, all actual warning states as well immediately after a login of a physician draws the physicians attention to each patient or device suffering from a major problem in as short a time as possible.

Furthermore, providing for the possibility not only to configure the rule base in order to define certain warning states, the physician shall have the possibility to select all or only a part of the warning states defined by the rules in the rule base for immediate display after login. Providing for such selection of warnings states to be immediately displayed by a warning symbol allows a physician to select those warning states he is interested in, in particular if the rules and the rule base are defined by another expert.

In a preferred mode, the processing unit is adapted to generate a display control signal immediately after login of a physician such that the display control signal causes a list of all names of all patients or devices assigned to that physician and either an alarm symbol, or a warning symbol or an ok-symbol for each listed patient or device. Thus, the physician is provided with a comprehensive overview of the states of all of the patients or devices associated to that physician.

Preferably, in such list those patients or devices for which an alarm state is given are listed atop together with an alarm symbol.

In a preferred embodiment of the management system the data interface comprises a select interface, which is connected to the processing unit. The processing unit is adapted to retrieve further information assigned to a patient or device in response to a first type of a select signal received via the select interface and to generate a display control signal to display said further information. Said further information preferably comprises information to a set of categories characterizing a general status of the selected patient or the selected device. In a further preferred embodiment a second type of a select signal is optionally provided to select one of the categories displayed thereby initiating a display of the actual data which are stored in the data base. This data management system allows easy three-level retrieval of the data stored in the data base. It is an advantage of the preferred embodiment that the data stored in the data base itself can be viewed by a physician.

The object of the invention is also achieved by a data storage means which comprises a program for the forming of a graphical display of physiological or technical data or both. The program comprises the steps of retrieval of data from a data base, processing of the data and generating a display control signal dependent on such processing of the data.

Preferably, the step of processing said retrieved data comprises the sub steps of accessing a rule base, applying rules stored in the rule base on said retrieved data, determining alarm states defined by said rules and generating a display control signal displaying an alarm symbol if an alarm state is determined.

A further improvement of the data management system comprises a communication unit which is adapted to generate a notification signal in case of a critical situation as detected by the processing unit. Based on this notification signal, a notification message is sent to the physician who is assigned to the patient showing the critical state via a configurable communication pathway, e.g., E-Mail, Fax, SMS or Pager. For this purpose, the communication unit comprises a notification message configuration database comprising physician identification data elements which identify the physician to be notified by a respective E-mail address or a Fax number or a mobile phone number.

In a preferred embodiment, the notification message may contain a selection of the following information: a patient identification code, the implant type and serial number, a short description of the critical condition, the parameter values being in the critical range and date and time of detection. In the preferred embodiment the notification message configuration database comprises information selection data elements identifying the information selected for transmission along with the notification message.

Furthermore, this notification function is configurable to the patient's individual needs and to the physician's general preferences, i.e. the physician may select for each individual patient about which critical situations he wants to be notified. For this purpose the notification message configuration database comprises message trigger identification data elements which identify the situations which shall trigger the transmission of a message.

In it's most preferred embodiment the notification message configuration database is organized such that the physician identification data elements, the message trigger identification data elements and the information selection data elements are assigned to individual patients. The information selection data elements may each or in groups be assigned to a respective message trigger identification data element in order to allow automatic transmission of different information depending on the situation which triggers the transmission of the notification message.

It is to be understood, that the program stored on the data storage means can be further adapted to perform all the functionality described before.

The invention shall now be further disclosed based on an exemplary embodiment together with the figures.

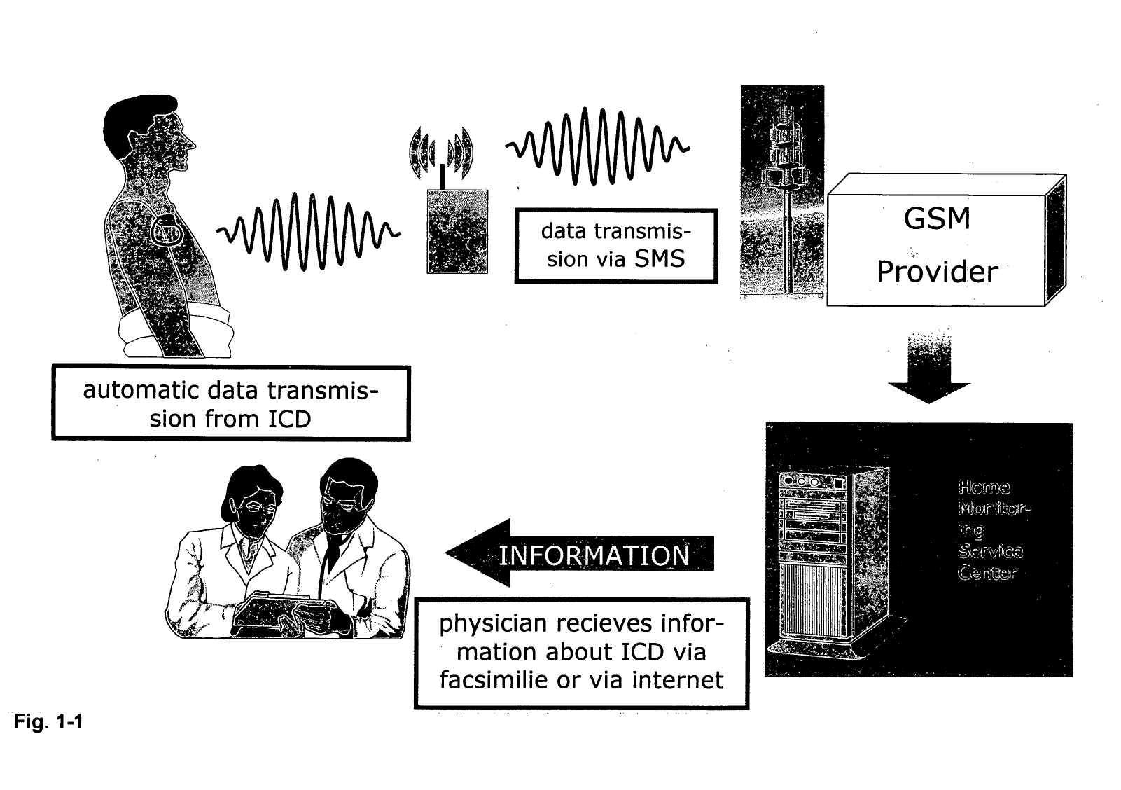

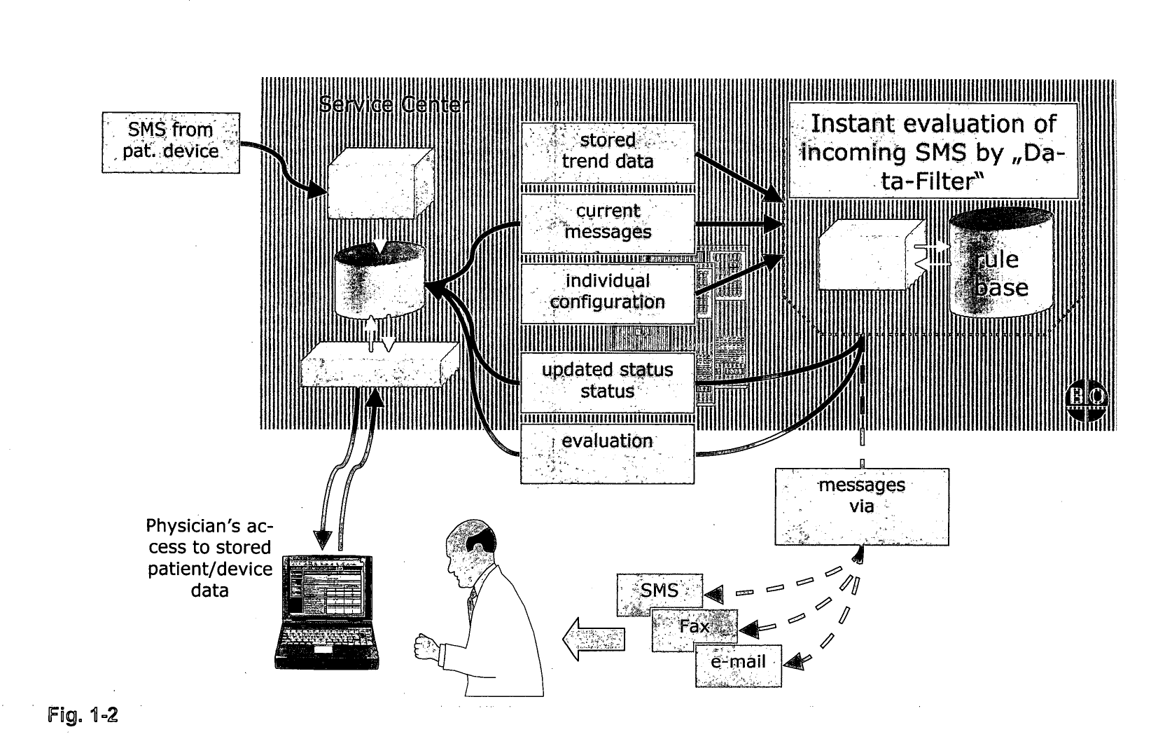

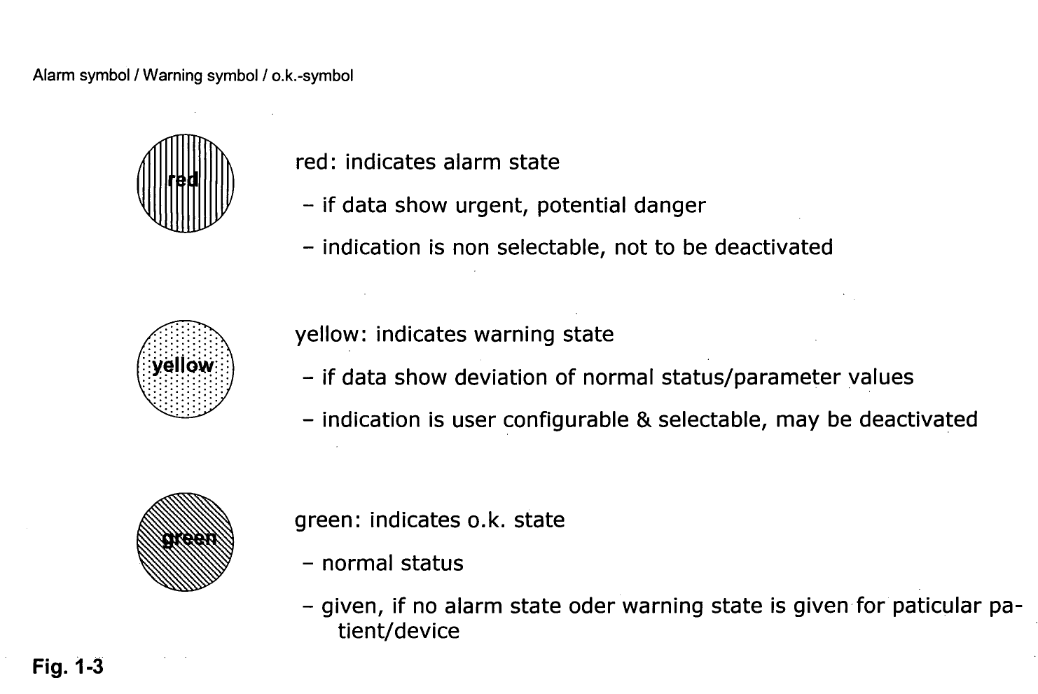

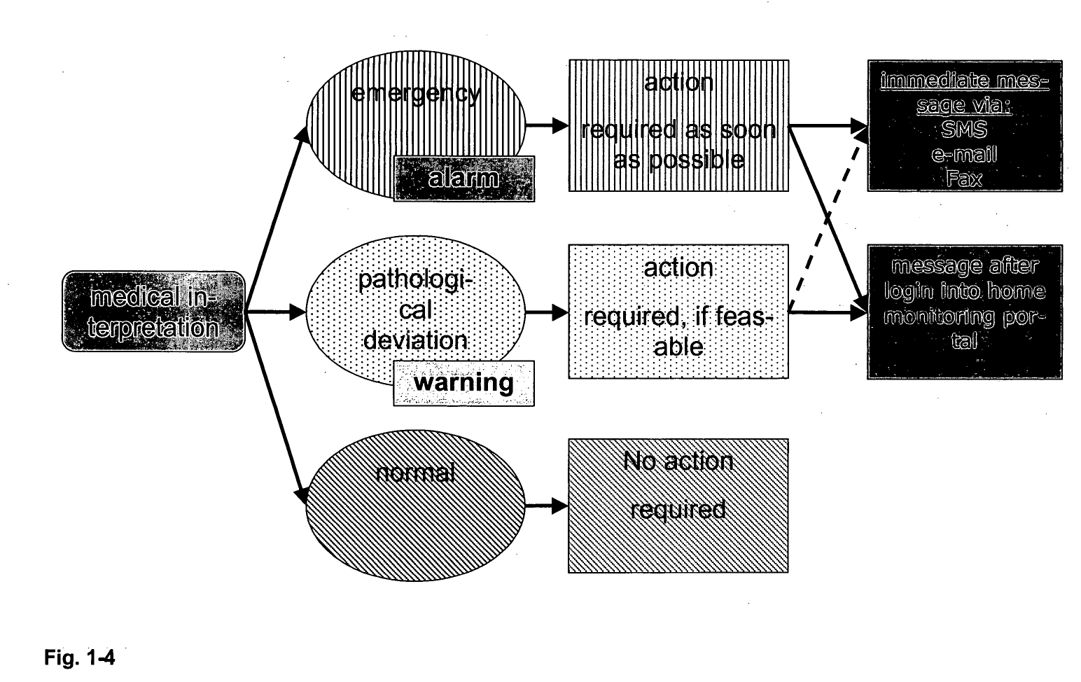

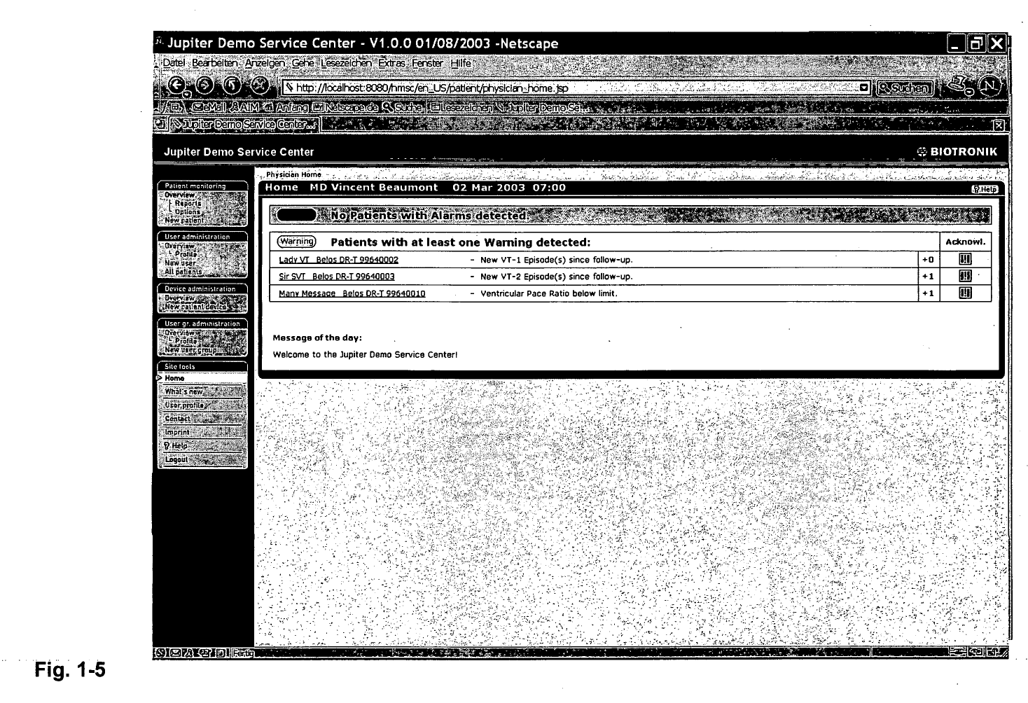

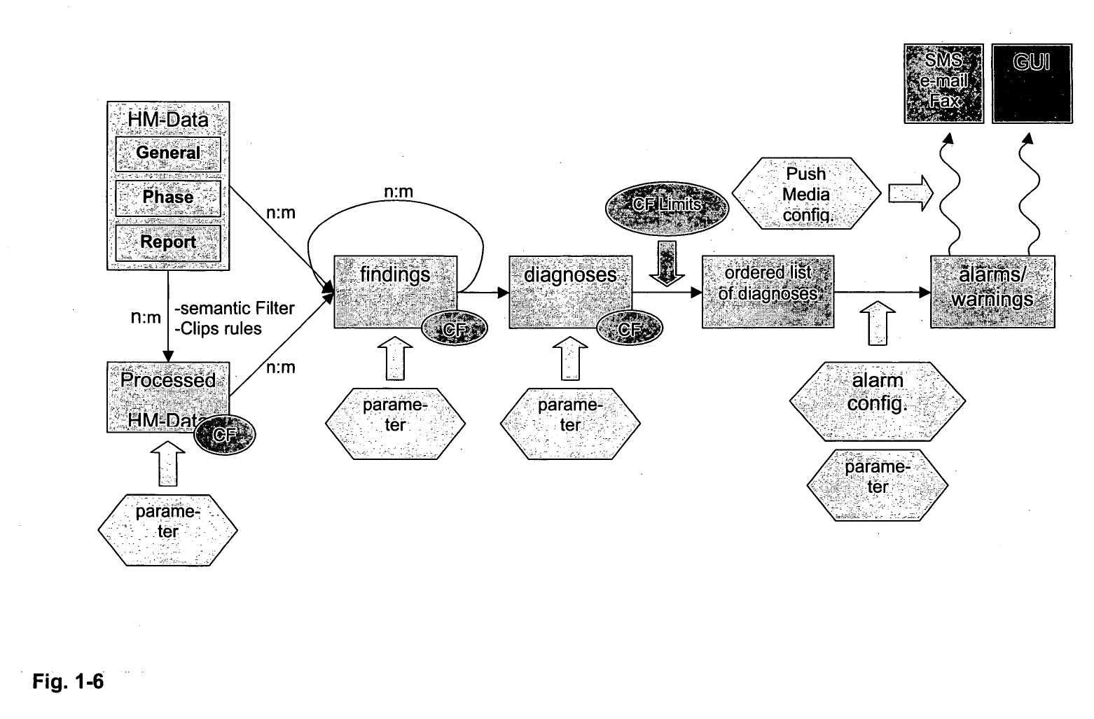

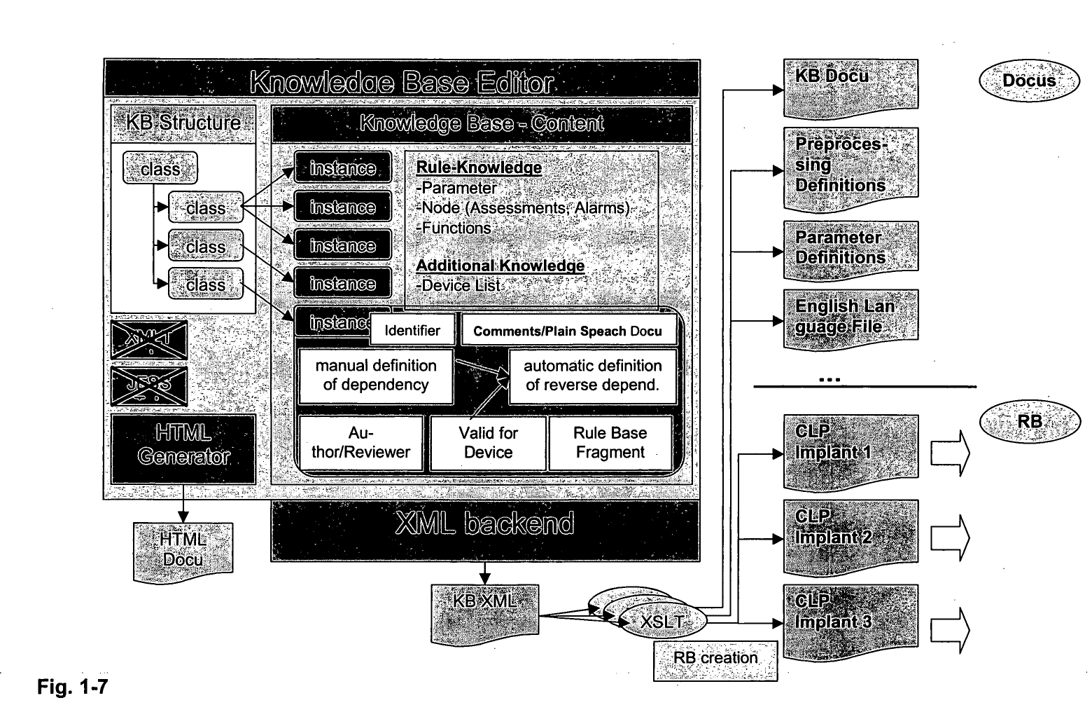

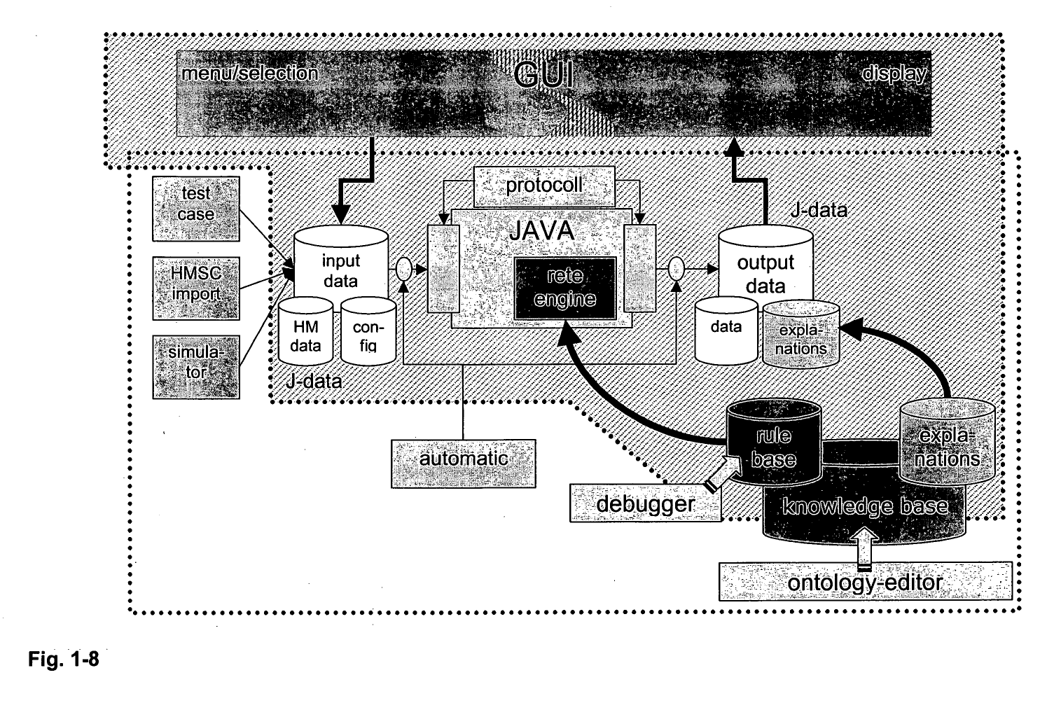

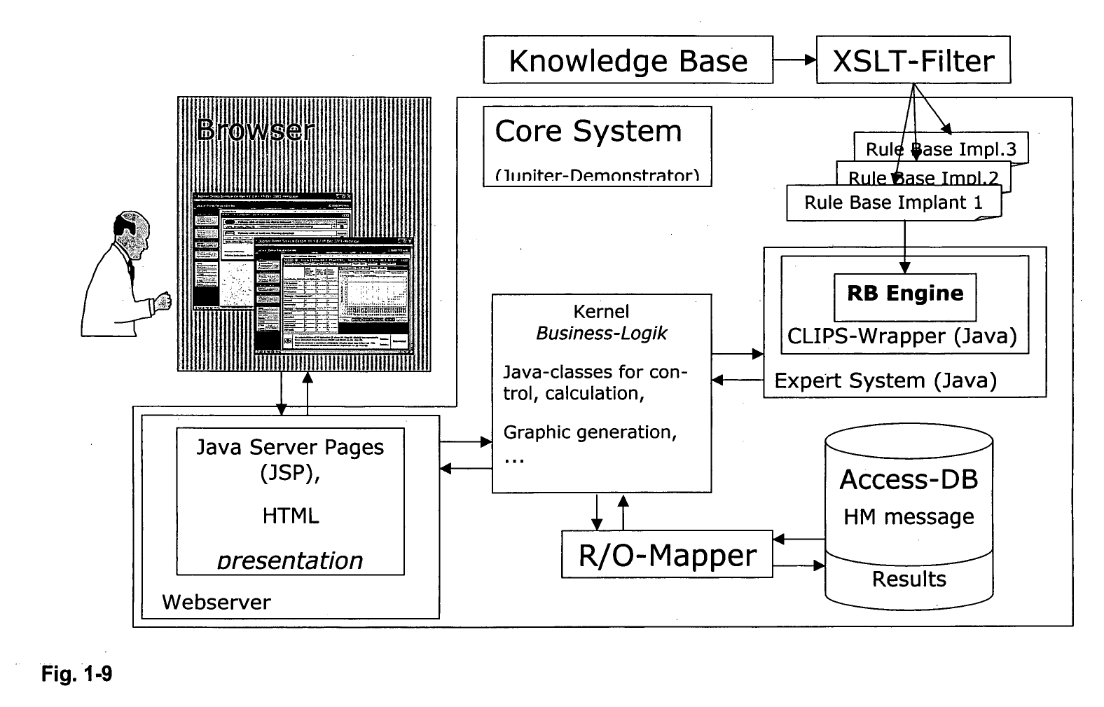

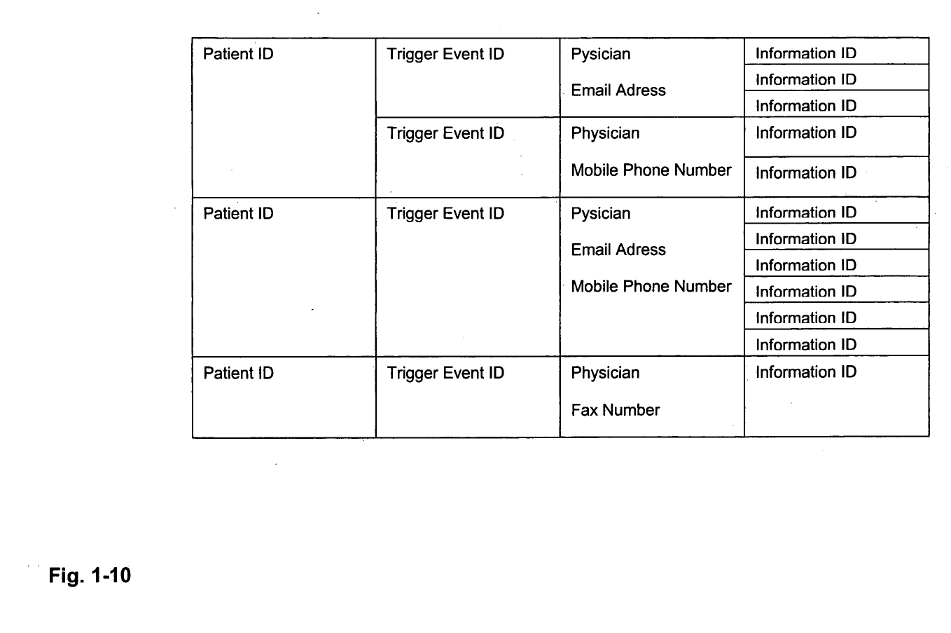

FIG. 1-1: an overview of a home monitoring system for a patient's health care;

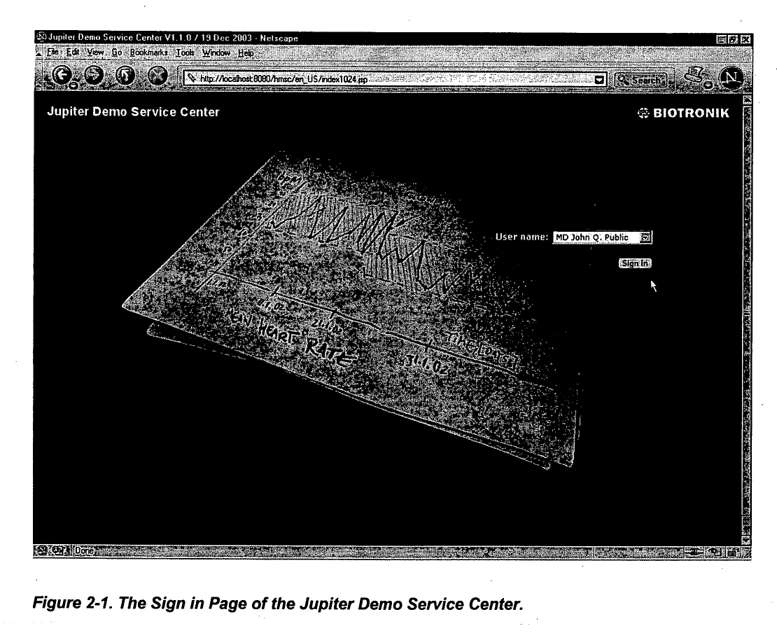

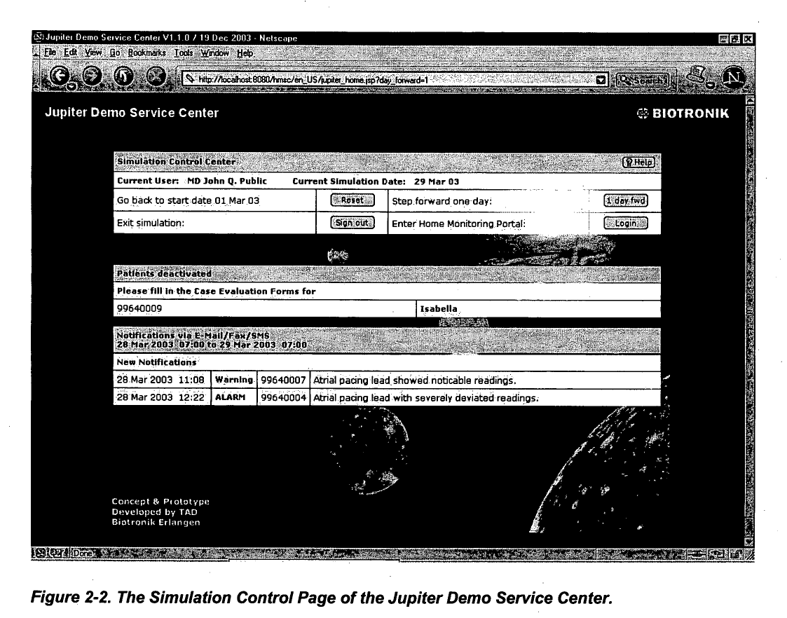

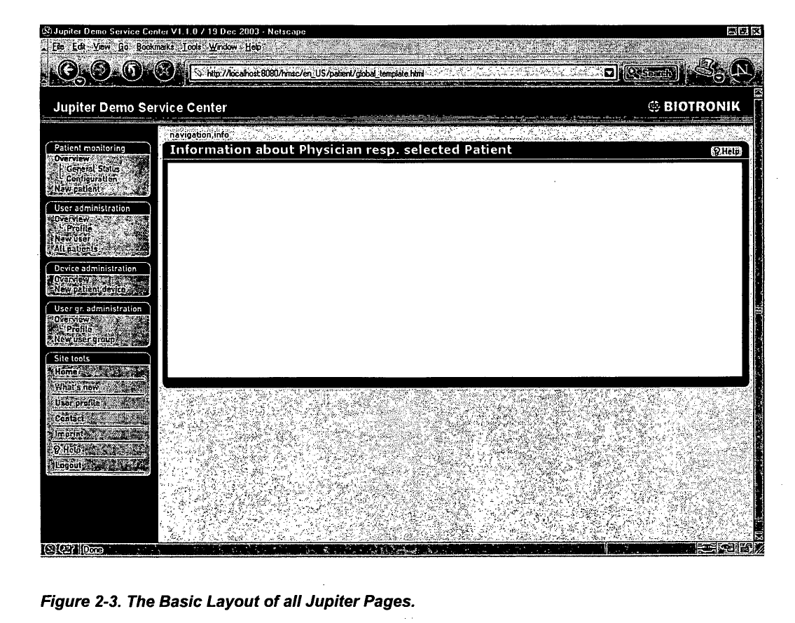

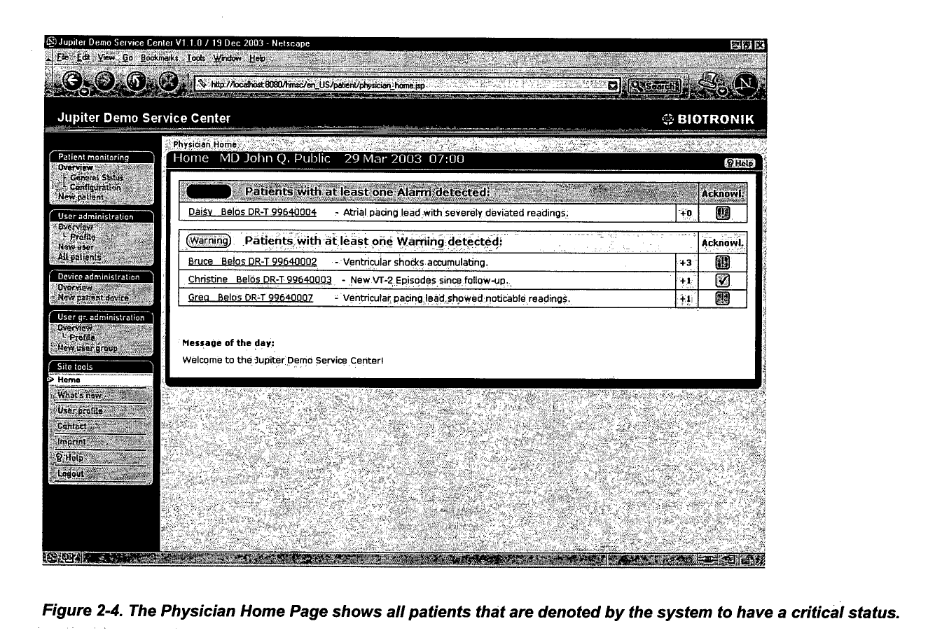

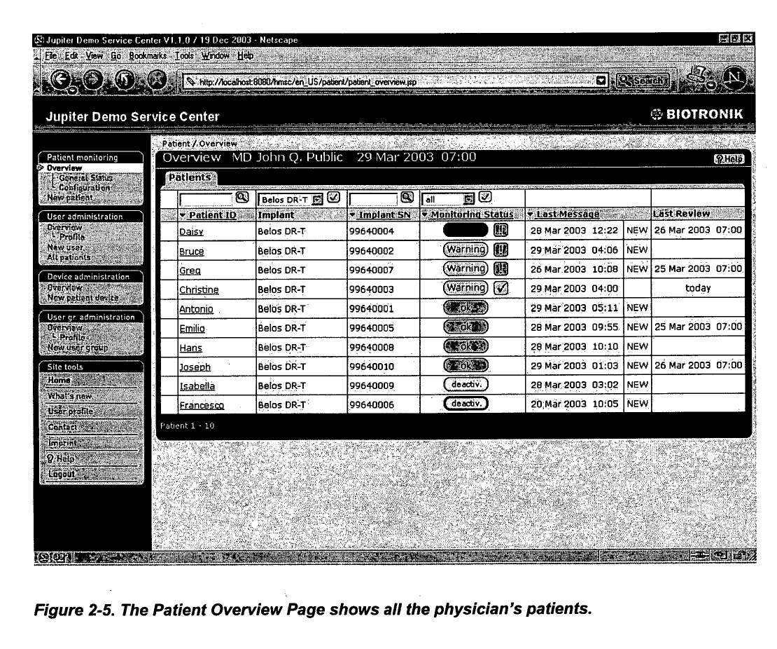

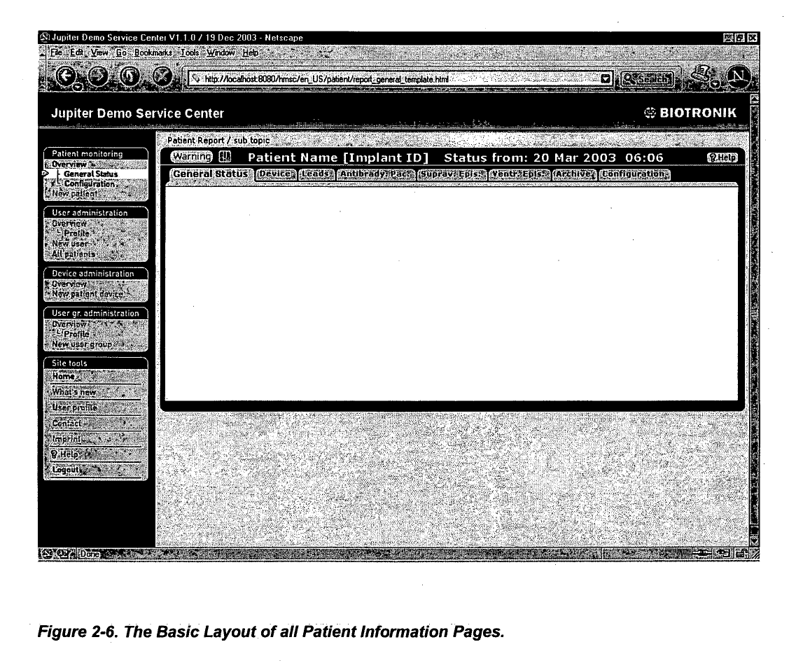

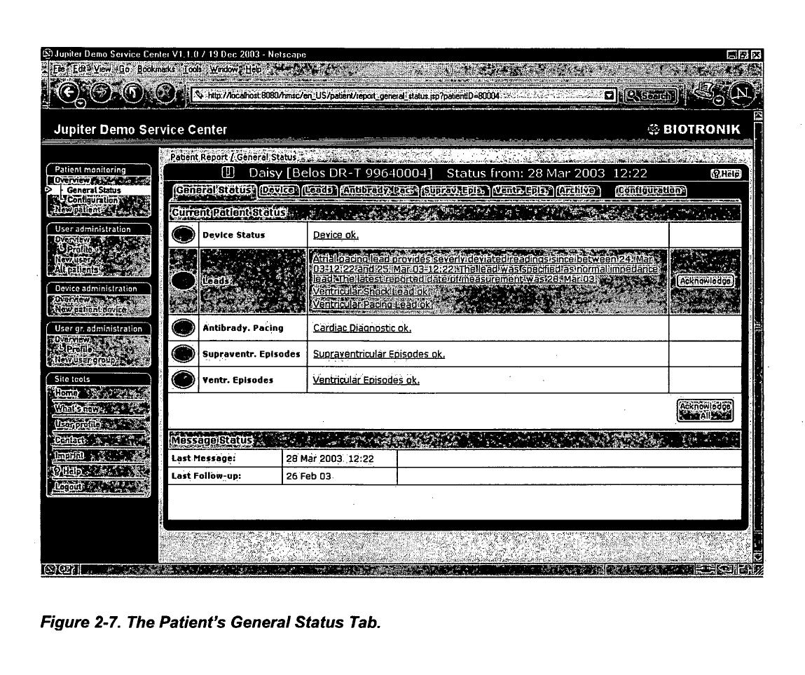

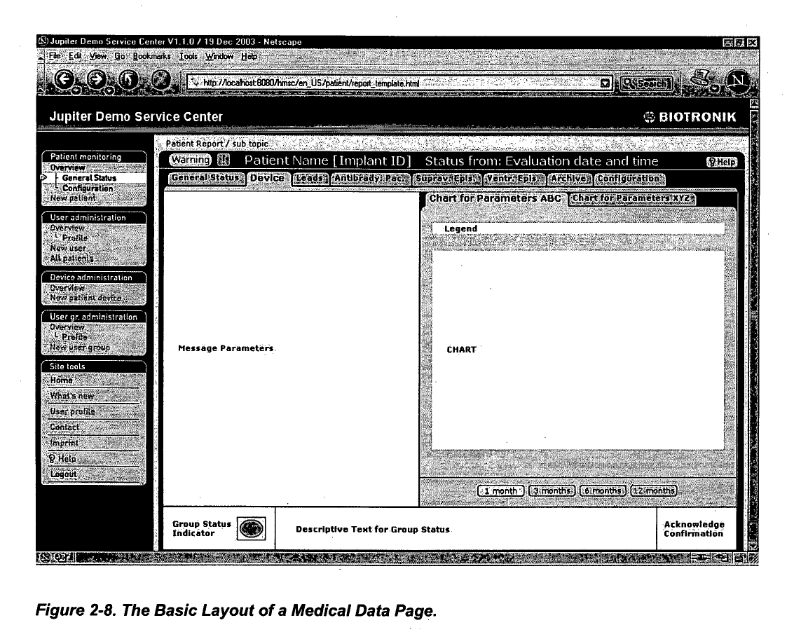

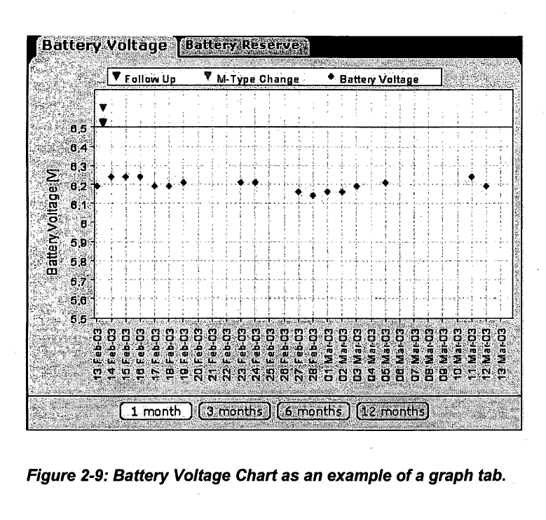

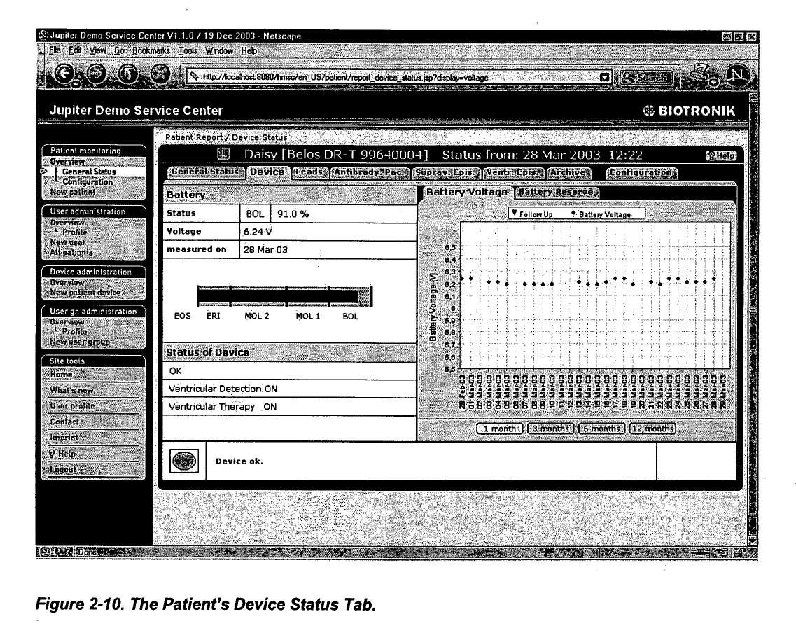

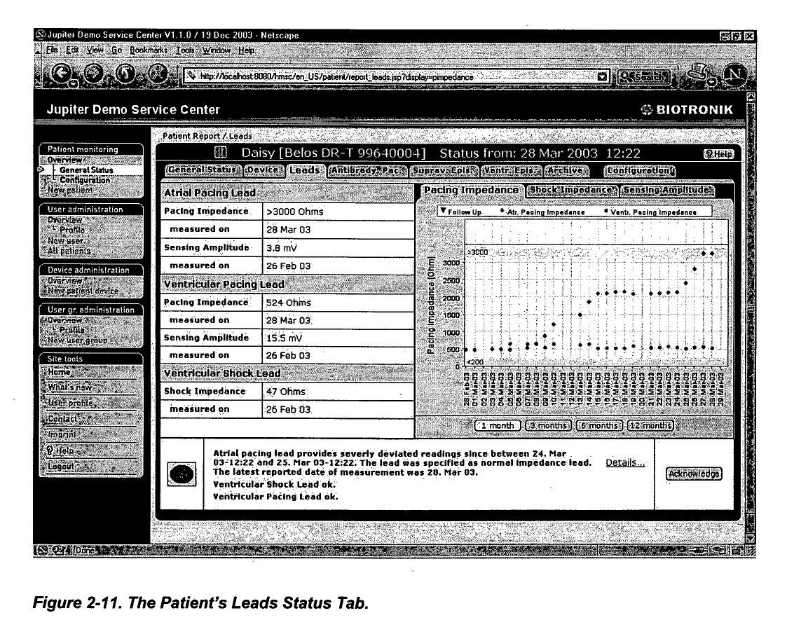

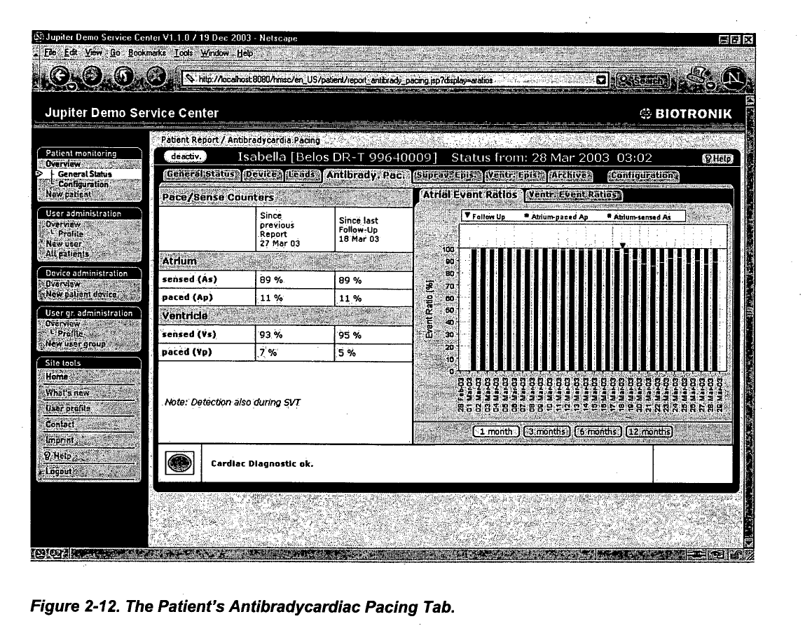

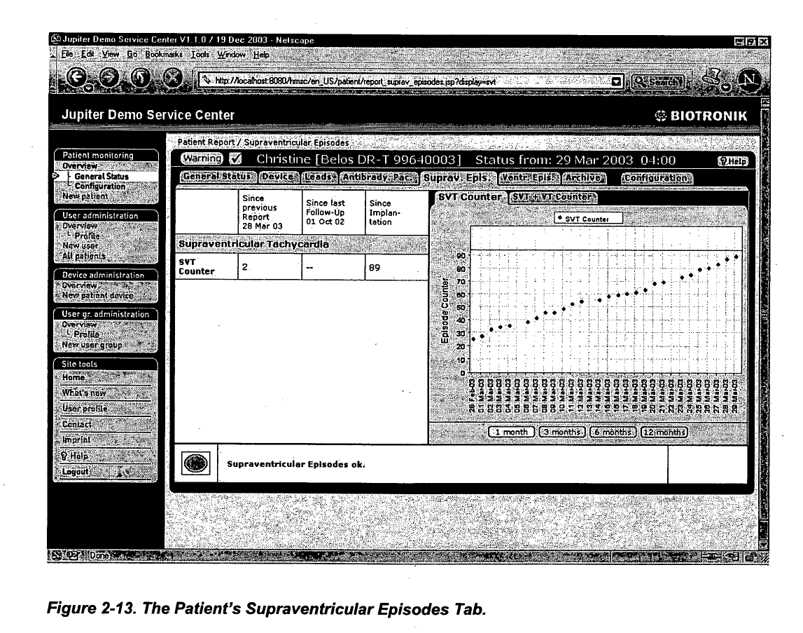

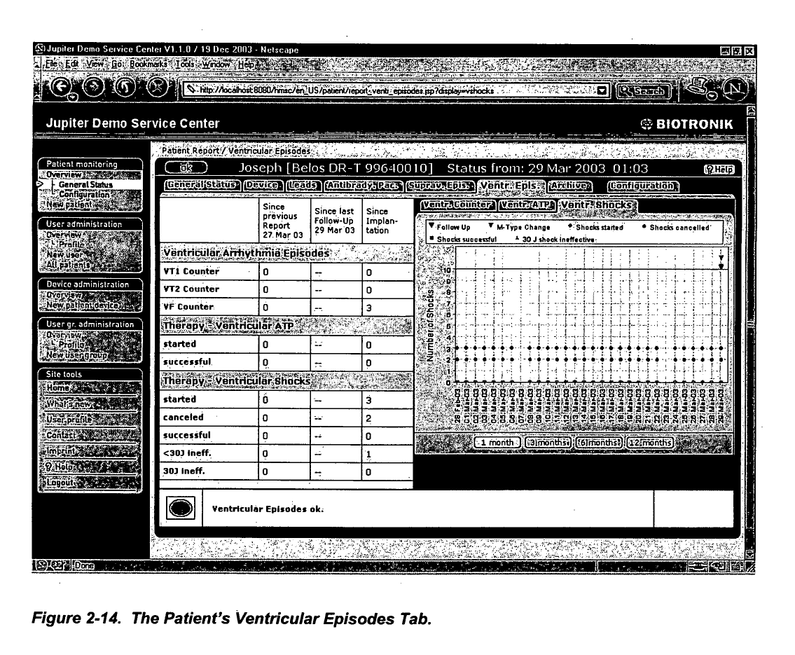

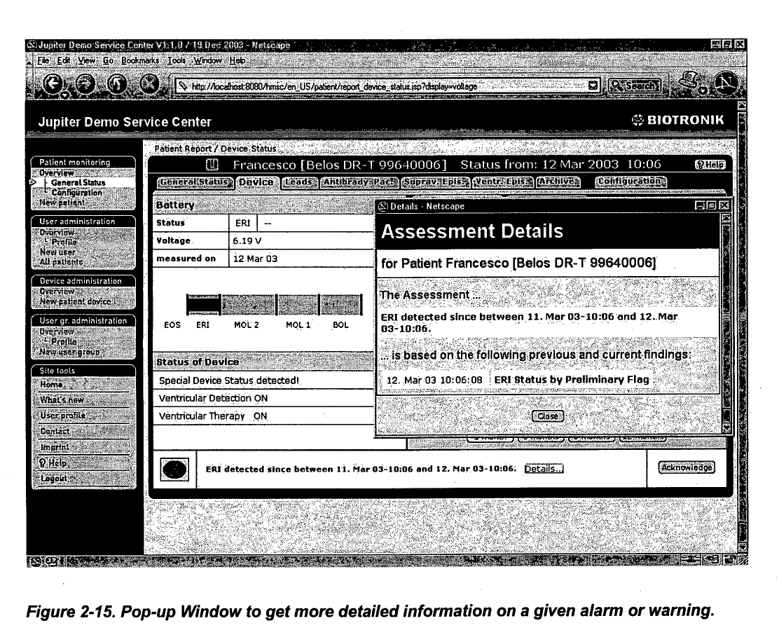

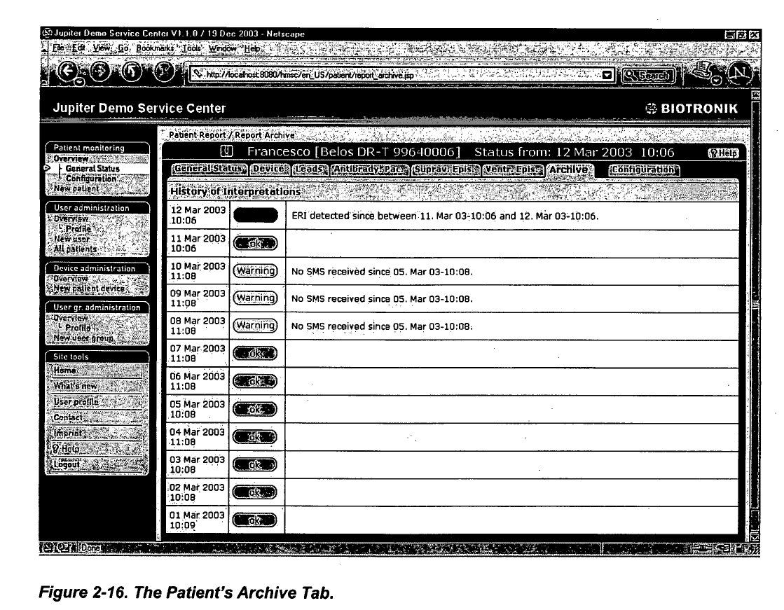

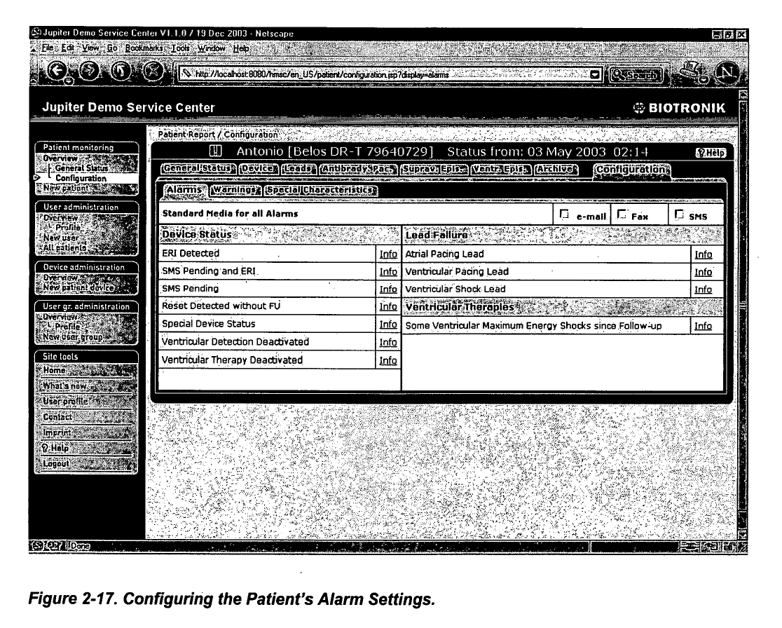

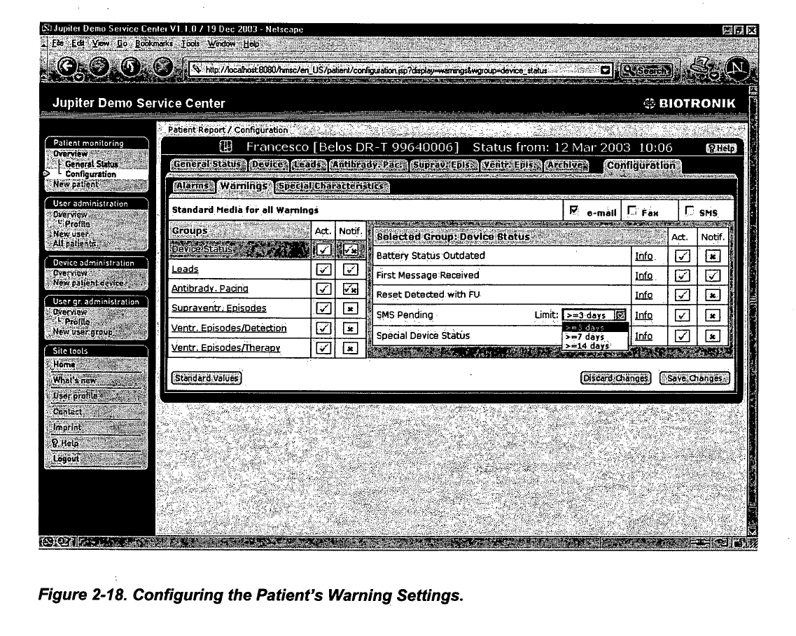

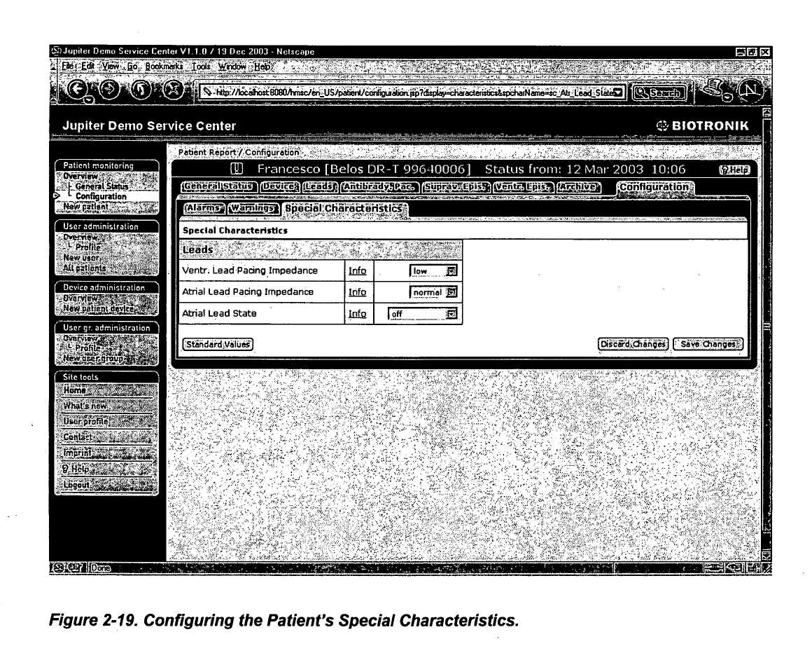

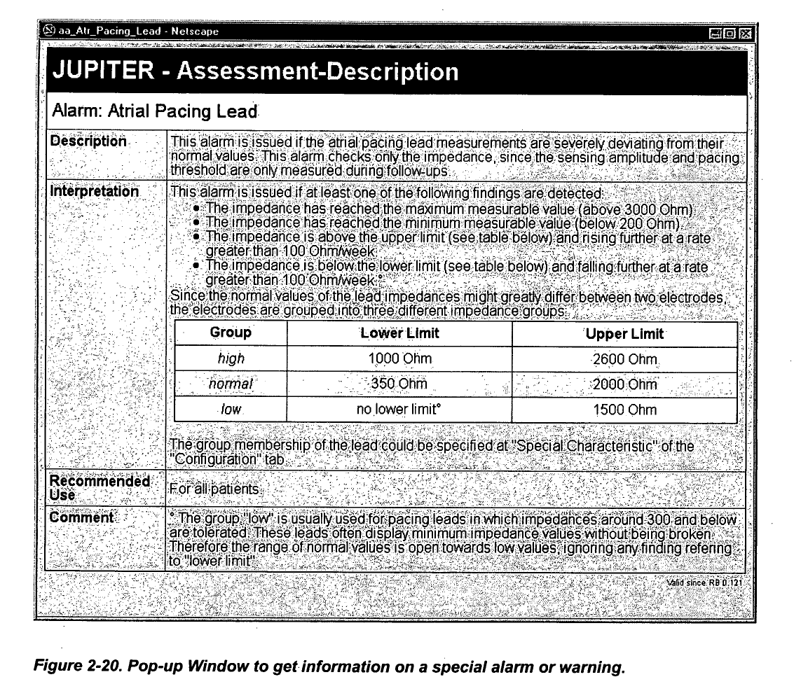

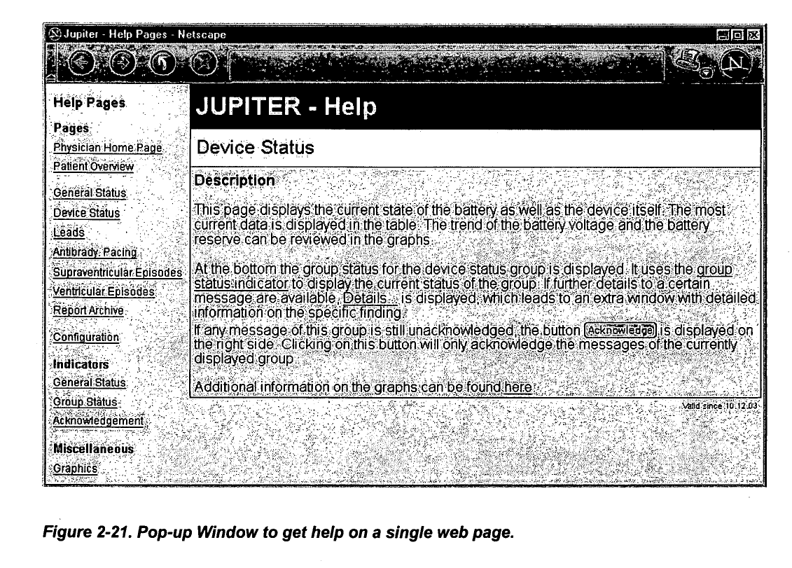

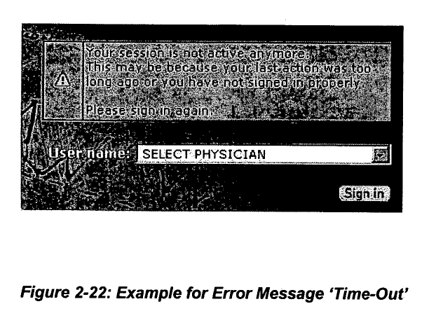

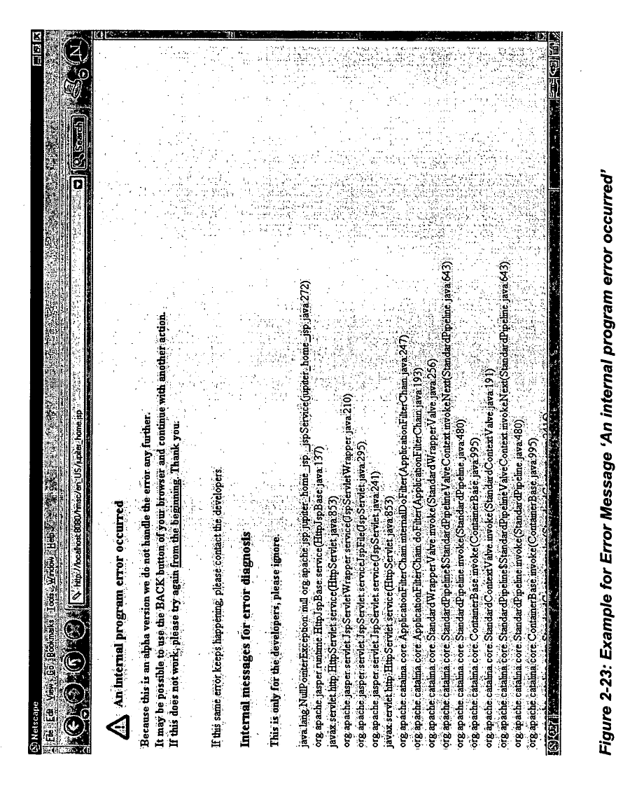

FIG. 1-2: an overview of the data management system as part of the home monitoring system shown in FIG. 1;

FIG. 1-3: the three main status indicator symbols;

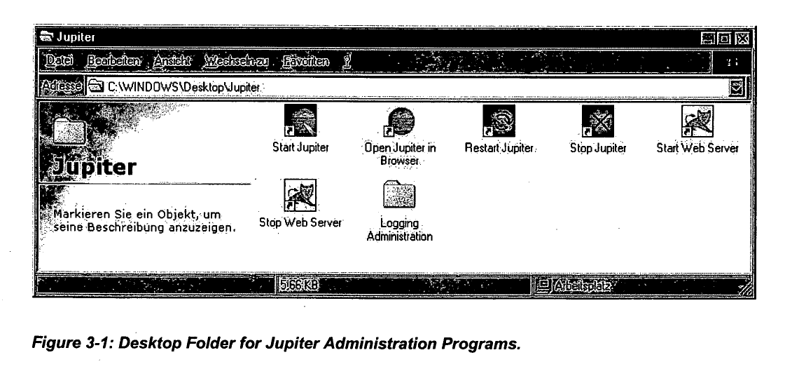

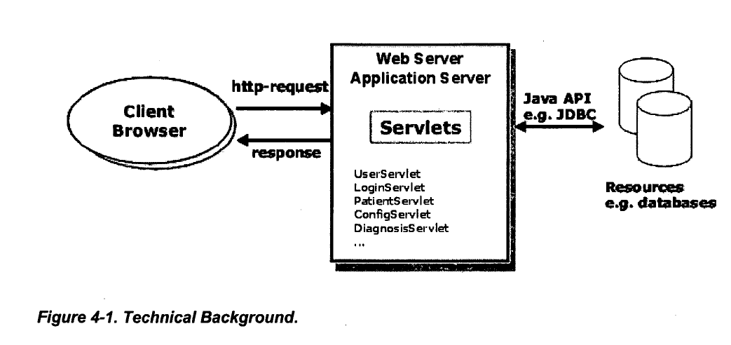

FIG. 1-4: a rough overview of the rules for generating and the meaning of either one of the symbols shown in FIG. 3;

FIG. 1-5: an overview of a graphical user interface provided by the data management system for a physician;

FIG. 1-6: a structure of knowledge nodes which form a knowledge base, which in turn provides a basis for a rule base;

FIG. 1-7: a rough representation of the engine transforming the knowledge base into the rule base;

FIG. 1-8: an overview of the system components of the data management system;

FIG. 1-9: an overview of the system architecture of the data management system; and

FIG. 1-10: an example for a notification message configuration database as a part of a communication unit which is a part of the data management system.

FIG. 1-1 shows a patient with an implanted medical device, for example an implantable cardioverter/defibrillator (ICD). The ICD is able to initiate an automatic data transmission to an external device in the close proximity of the patient. The external device (patient device) initiates a data transmission via short message strings using a mobile communication infrastructure according to the GSM standard. The short message strings (SMS-messages) are received by a home monitoring service center (HMSC) where the data content of each short message string is evaluated and stored. The data stored in the home monitoring service center is evaluated and information for a physician is generated which is submitted to the physician via facsimile or via internet.

FIG. 1-2 shows the core components of the data management system realized in the home monitoring center from a physicians perspective. The data management system comprises a computer system which provides for a data base and for means to evaluate data stored in the data base. These means for evaluation of data comprise an expert system program which is adapted to evaluate stored data based on rules stored in the rule base. Data evaluation leads to messages submitted to a physician.

The physician has access to the data stored in the data base via an interface, for example a notebook being connected to the service centers computer. The notebook serves as well as an input interface allowing the physician to configure some of the rules in the rule base.

FIG. 1-3 illustrates symbols shown to the physician for each patient or device he is responsible for. These symbols will appear on the user interface (i.e. the laptop screen) immediately after login by a physician. A red alarm symbol indicates an alarm state as defined by the rules in the rule base. The rule base is configured in a manner to determine an alarm state if data stored in data base indicates a potential health danger which requires urgent action. The physician can not deactivate indication of alarm symbols.

A different type of symbol is given by a warning symbol which indicates a warning state if the data stored in the data base show a deviation of a normal status or deviation of parameter values from normal values. Via the user interface, the physician is able to configure the indication of warning states. He may deactivate the indication of some warning states.

If neither an alarm state nor a warning state is determined by the data management system based on the rule base, an ok-symbol is shown to the physician.

FIG. 1-4 shows the concept of indicating three different states, alarm state, warning state and ok-state, in further detail. In particular, from FIG. 1-4 it is apparent, that the data management system initiates an immediate message to a physician, if an alarm state is detected. The message will be send as short message string, e-mail or facsimile. The message indicating an alarm status is send even if the physician is not logged in into the data management system. A warning state is only indicated by a warning symbol, if the physician logs into the home monitoring portal of the data management system.

FIG. 1-5 shows a screen shot of the user interface indicated to a physician after login into the home monitoring portal.

FIG. 1-6 is a representation of the structure of the knowledge nodes which are part of the knowledge base and represent an expert's or a physician's knowledge about potential health complications of a patient or technical complications of a device. The knowledge base is defining the rules for evaluating the data stored in the data base and thereby defines the rule base.

FIG. 1-7 does show how the knowledge base defines the rules of the rule base. Please note that in the figure the shortcut RB is used for rule base and KB is used for knowledge base.

FIG. 1-8 is a further overview of the system components of the data management system. In particular it is shown, how a Java™ engine generates the information displayed on a graphical user interface (GUI) based on the rules defined in the rule base (RB) and derived from the knowledge base (KB).

FIG. 1-9 shows a further overview of the system architecture of the data management system.

Further features and further details of operation of the data management system become apparent from the following Jupiter Demonstrator Manual included herewith.

It is to be noted, that the Jupiter Demonstrator described herein is a simulator showing the functionality and the graphical user interface for a system as claimed with the claims. Those features specific for the simulator and to be changed in a real life system are clearly indicated in the following description.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. Data management system for processing of physiological or technical data or both to generate a display control signal,
with a data interface, which comprises
a patient data interface to receive data, which represent physiological parameter of a patient or technical parameter of a medical device, in particular of an implant like a cardiac pacemaker or a defibrillator, cardioverter or the like, and
a user interface to receive data to be entered by a user,
with a data base adapted to store data received via the patient data interface and to retrieve stored data, and
with a processing unit which is at least indirectly connected to the user interface, said processing unit is adapted to retrieve and to process data stored in the data base and to create a display control signal for a graphical data display such that the display control signal depends on said data,
characterized in that,
said processing unit is connected to a rule base and adapted to process said data according to rules stored in the rule base
said rule base comprises rules defining alarm states such that an alarm state is to be determined by the processing unit, if the data stored in the data base indicate an acute health disaster of a patient or an acute failure of a device,
wherein the processing unit is adapted to create a display control signal for displaying an alarm symbol dependent on a user identification signal received from the user interface such that for each patient or device being assigned to an identified user all actual alarms states are immediately displayed by an alarm symbol.

2. Data management system according to claim 1, wherein
the rule base comprises rules which define a warning state such that an warning state is to be determined by the processing unit if said data indicates an upcoming health complication or a minor technical failure, and
the processing unit is adapted to generate a display control signal for displaying for each patient or device being assigned to an identified user a warning symbol on a display, if for said patient or device a warning state as defined by the rule base is given by an actual set of data for said patient or device.

3. Data management according to claim 2, wherein the processing unit is adapted to generate a display control signal to display an ok-symbol for each person or device for whom or which no warning state or alarm state is given.

4. Data management system according to one of claims 1 to 3, wherein the processing unit is adapted to receive a user identification signal via the user interface and to immediately generated a display control signal for immediately displaying all actual alarm symbols given by an actual set of data being assigned to patients or devices assigned to the user identified by the identification signal.

5. Data management system according to claim 2 and 4, wherein the processing unit is adapted to generate a display control signal immediately after receiving a user identification signal said display control signal being adapted to display all actual warning states, which are previously selected and which are given for the patients or devices being assigned to a user, which is identified by the user identification signal.

6. Data management system according to one of claims 1 to 5, wherein the processing unit is adapted to generate a display control signal to display a list of all names of all patients or devices assigned to an identified user and to display for each patient or device an alarm symbol or a warning symbol or an ok-symbol associated to said names.

7. Data management system according to claim 6, wherein the processing unit is adapted to generate the display control signal for generating a display such that all names of patients or devices related to an actual alarm state are listed atop together with an alarm symbol.

8. Data management system according to claim 6, wherein the data interface comprises a select interface, which is connected to the processing unit and wherein the processing unit is adapted to retrieve further information assigned to a patient or a device being selected by a select signal received via the select interface and to generate a display control signal to display that further information.

9. Data management system according to claim 8, wherein said further information to be displayed for a selected patient or device comprises information to a set of categories characterizing a general status of the patient or the device.

10. Data management system according to claim 9, wherein the processing unit is adapted to allow a selection of each of the categories describing a general status of a patient or device and to initiate a display of all actual data being stored for said selected category.

11. A data storage means comprising a program for performing a graphical display of physiological or technical data or both, the program comprising the steps of:
retrieval of data from a data base
processing of the data
generating a display control signal dependent on said processing of the data

12. Data storage means according to claim 11, where a said step of processing said retrieved data comprises the sub steps of
accessing a rule base
applying rules stored in the rule base on said retrieved data
determining alarm states defined by said rules and
generating a display control signal displaying an alarm symbol if an alarm state is determined.

13. Data management system according to claim 1, wherein the processing unit is connected to a communication unit which is adapted to generate a notification signal upon detection of a warning state or an alarm state as detected for a patient by the processing unit.

14. Data management system according to claim 13, wherein the data management system comprises a communication interface connected to the communication unit and being adapted to respond to the notification signal by transmitting of a notification message to a physician who is assigned to the patient showing selected information regarding the warning state or the alarm state via a selected configurable communication pathway, e.g., E-Mail, Fax, SMS or Pager.

15. Data management system according to claim 13 or 14, wherein the communication unit comprises a notification message configuration data base which can be individually configured by the physician using the user interface in a way that an individual notification profile can be created for each patient.

16. Data management system according to claim 15, wherein the notification message configuration data base comprises physician identification data elements, message trigger identification data elements and information selection data elements which each are assigned to an individual patient and to which each a value representing a communication pathway, a message triggering situation and information to be transmitted, respectively, can be assigned in groups or individually in order to represent notification profiles or configuration settings which can be modified, stored, and applied to other patients as well.
